(19) United States
(12) Patent Application Publication
(10) Pub. No.: US 2014/0012742 A1
(43) Pub. Date: Jan. 9, 2014

(54) ELECTRONIC PROCESSING OF PAPER INVOICES

(71) Applicants: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(72) Inventors: Carrie Anne Hanson, Charlotte, NC (US); Scott R. Enscoe, Charlotte, NC (US); Alexander C. Wittkowski, Charlotte, NC (US); David M. Grigg, Rock Hill, SC (US); Daniel David, Charlotte, NC (US); Katherine Dintenfass, Charlotte, NC (US); Ray R. Hernandez, Austin, TX (US); Brett Newman, Burlingame, CA (US); Leo Kopelow, San Francisco, CA (US); Yameng Li, Berkeley, CA (US); Nicole Chen, San Francisco, CA (US); Nicholas Sharp, San Francisco, CA (US)

(73) Assignee: BANK OF AMERICA CORPORATION, Charlotte, NC (US)

(21) Appl. No.: 13/543,644

(22) Filed: Jul. 6, 2012

(51) Int. Cl. G06Q 20/14

(52) U.S. Cl. 705/40

(57) ABSTRACT

Embodiments of the invention are directed to systems, methods, and computer program products for electronic processing of paper invoices. The invention allows provides a user with information about a paper invoice through the use of the user's mobile computing device. In some embodiments, a method comprises providing a computer processor executing computer readable code structured to cause the computer processor to (a) receive information associated with an image of the invoice, wherein the image is captured by a mobile computing device of the user; (b) identify the invoice based at least partially upon the information associated with the image of the invoice; (c) determine financial institution information associated with the invoice; and (d) present, via the mobile computing device of the user, an indication of the financial institution information.

### BACKGROUND

Many consumers today conduct much of their banking electronically. For instance, consumers may access a website hosted by their financial institution that provides account information, such as balances, credits, and debits. Additionally, many consumers now use a mobile computing device, such as a mobile phone, to conduct their banking. By accessing a mobile banking application, consumers can check their account balance, transfer funds, make deposits, and perform other banking functions.

Despite the use of electronic banking, most consumers still receive paper invoices from various service providers. For instance, consumers regularly receive a monthly bill from utility companies (e.g., telephone, cable, etc.), insurance companies (e.g., car insurance, home insurance), and financial institutions (e.g., mortgage statement, etc.) Additionally, consumers regularly receive paper invoices after visiting medical professionals (doctors, dentists, etc.) or paying for specialty services (plumbing services, pest control services, etc.).

There are numerous problems associated with the receipt of paper invoices. First, a consumer might receive a paper invoice, file it away, and then subsequently forget whether the invoice has been paid. Second, upon receiving a paper invoice, it is often time consuming and cumbersome to transfer the information in that invoice into an electronic format that can be used in connection with online banking functionality. Third, consumers might receive a paper invoice from a merchant, but yet have no idea whether there are other merchants that provide products or services that are similar to or more favorable than the products or services that the user already purchases. Fourth, upon receiving a paper invoice, it is difficult for a consumer to determine whether the consumer could be eligible for a promotion or discount based upon the user's affiliation with a certain financial institution.

Accordingly, there exists a need for an improved method of processing paper invoices. Specifically, there exists a need for a method for processing paper invoices through the use of a mobile computing device, wherein the processing method provides the user with information about the paper invoice, including but not limited to whether the invoice has been paid and whether there are any other merchants that provide products or services that are similar to the products and services described in the paper invoice.

### BRIEF SUMMARY

Embodiments of the invention relate to apparatuses, methods, and computer program products that provide electronic processing of paper invoices.

In some embodiments, an apparatus is provided that comprises a communication device, and a processing device communicable coupled to the communication device, wherein the processing device is configured to (a) receive information associated with an image of the invoice, wherein the image is captured by a mobile computing device of the user; (b) identify the invoice based at least partially upon the information associated with the image of the invoice; (c) determine financial institution information associated with the invoice; and (d) present, via the mobile computing device of the user, an indication of the financial institution information.

In some embodiments, the processing device configured to receive information associated with an image of the invoice is further configured to receive an image of the invoice.

In some embodiments, the processing device configured to identify the invoice is further configured to identify at least one of the name of the first merchant, the invoice number, the products or services subject to the invoice, or the amount of the invoice.

In some embodiments, the processing device configured to identify the invoice is further configured to analyze the image of the invoice.

In some embodiments, the processing device configured to determine financial institution information associated with the invoice is further configured to determine whether the invoice has been paid by the user.

In some embodiments, the processing device configured to present an indication of the financial institution information is further configured to present an indication of whether the invoice has been paid. In some embodiments, the processing device configured to present an indication of whether the invoice has been paid is further configured to allow the user, via the mobile device of the user, to add the invoice to an online representation of the user's expenses.

In some embodiments, the processing device configured to determine financial institution information associated with the invoice is further configured to identify a second merchant, wherein the second merchant provides products or services that are similar to those offered by the first merchant.

In some embodiments, the processing device configured to present an indication of financial institution information is further configured to present an offer to enter into a transaction with a second merchant. In some embodiments, the processing device configured to present an offer to enter into a transaction with the second merchant is further configured to present an offer to enter into a transaction with a second merchant that has a preferred relationship with the user's financial institution.

In some embodiments, a method is provided for providing financial institution information associated with an invoice, wherein the invoice is issued by a first merchant to a user. The method comprises providing a computer processor executing computer readable code structured to cause the computer processor to: (a) receive information associated with an image of the invoice, wherein the image is captured by a mobile computing device of the user; (b) identify the invoice based at least partially upon the information associated with the image of the invoice; (c) determine financial institution information associated with the invoice; and (d) present, via the mobile computing device of the user, an indication of the financial institution information.

In some embodiments, a computer program product is provided for providing financial institution information associated with an invoice, wherein the invoice is issued by a first merchant to a user. The computer program product comprises a non-transitory computer-readable medium, wherein the non-transitory computer-readable medium comprises computer executable program code store therein, the computer executable program code comprises: (a) a first executable portion configured to receive information associated with an image of the invoice, wherein the image is captured by a mobile computing device of the user; (b) a second executable portion configured to identify the invoice based at least partially upon the information associated with the image of the invoice; (c) a third executable portion configured to determine financial institution information associated with the invoice; and (d) a fourth executable portion configured to present, via the mobile computing device of the user, an indication of the financial institution information.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for the processing of paper invoices, in accordance with an embodiment of the invention;

FIG. 2 is a flow diagram illustrating a more detailed process flow for the processing of paper invoices, in accordance with an embodiment of the invention;

FIG. 3 is a flow diagram illustrating a more detailed process flow for the processing of paper invoices, in accordance with an embodiment of the invention;

FIG. 4 is provides a block diagram illustrating an system and environment configured to perform the processing of paper invoices, in accordance with an embodiment of the invention;

FIG. 5 is a block diagram illustrating a user's mobile computing device of FIG. 4, in accordance with an embodiment of the invention; and

FIG. 6 is a mixed block and flow diagram of a system configured to perform the processing of paper invoices, in accordance with an embodiment of the invention.

### DETAILED DESCRIPTION OF EMBODIMENTS OF THE INVENTION

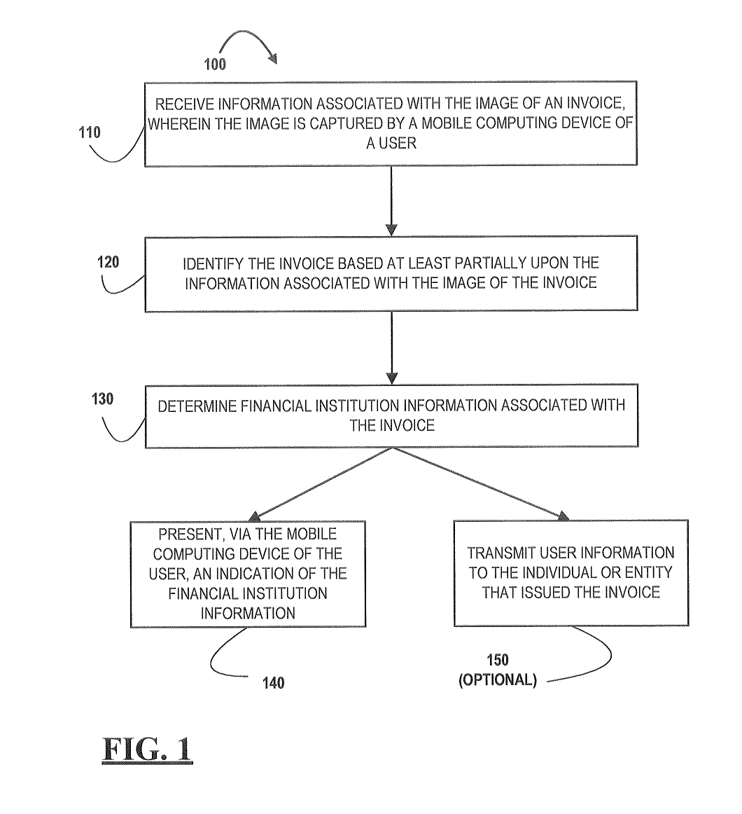

Referring now to FIG. 1, a general process flow 100 is provided for electronic processing of paper invoices. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive information associated with the image of an invoice, wherein the image is captured by a mobile computing device of a user. As represented by block 120, the apparatus is also configured to identify the invoice based at least partially upon the information associated with the image of the invoice. In addition, as represented in block 130, the apparatus is configured to determine financial institution information associated with the invoice. Lastly, at block 140, the apparatus is configured to present, via the mobile computing device of the user, an indication of the financial institution information.

The term “determine,” in some embodiments, is meant to have one or more of its ordinary meanings (i.e., its ordinary dictionary definition(s)), but in other embodiments, that term is meant to have one or more ordinary meanings of one or more of the following terms: decide, conclude, verify, ascertain, find, discover, learn, calculate, observe, read, and/or the like. Further, in some embodiments, the phrase “based at least partially upon,” is meant to have one or more of its ordinary meanings, but in other embodiments, that phrase is meant to have one or more ordinary meanings of one or more of the following terms and/or phrases: as a result of, because, after, if, when, in response to, and/or the like. Lastly, the term “mobile computing device” is meant to have one or more of its ordinary meaning, but in other embodiments, the phrase is meant to mean any one of the following: a tablet computer, a laptop computer, a mobile phone, a personal digital assistant, a gaming device, a smartphone or any other device with similar functionality.

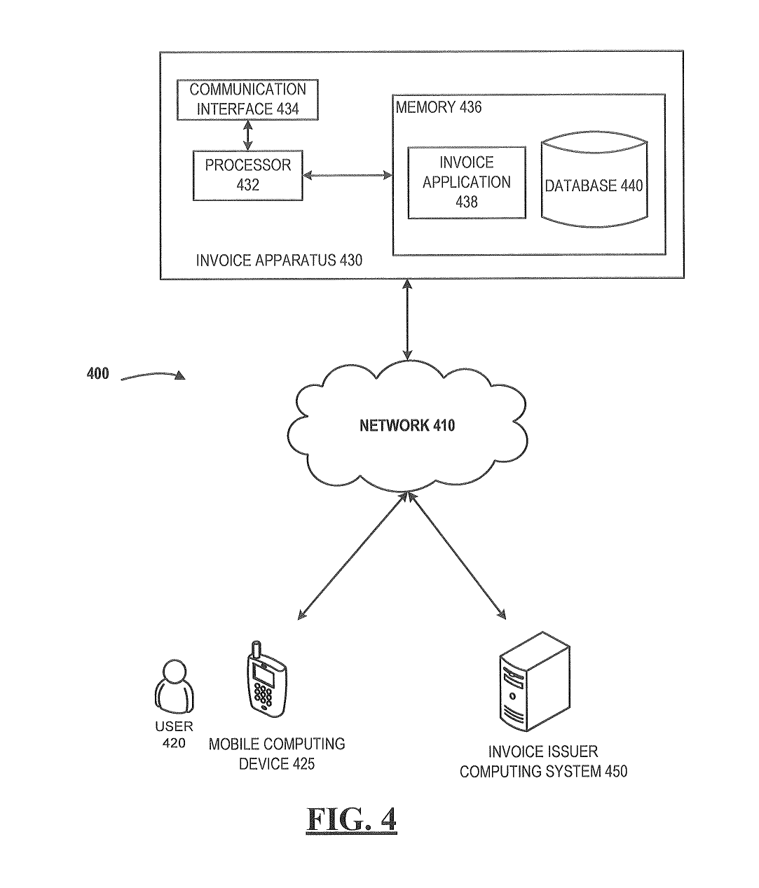

It will also be understood that the apparatus having the process flow 100 can include one or more separate and/or different apparatuses. For example, in some embodiments, a first apparatus (e.g., the mobile computing device 425 described in connection with FIG. 4) is configured to perform the portions of the process flow 100 represented by blocks 110 and 120, and a second apparatus (e.g., the invoice apparatus 430 described in connection with FIG. 4) is configured to perform the portion of the process flow 100 represented by blocks 130 and 140. Alternatively, in other embodiments, a single apparatus (e.g., the invoice apparatus 430, etc.) is configured to perform all of the portions of process flow 100 represented by blocks 110-140. In some embodiments, a single apparatus performs all of the portions of process flow 100 and has the combined functionality of invoice apparatus 430 and personal computing device 425.

Regarding block 110, the term “invoice” is meant to have one or more of its ordinary meanings (i.e., its ordinary dictionary definition(s)), but in other embodiments, that term is meant to have one or more ordinary meanings of one or more of the following terms: bill, receipt, offer, or coupon.

The term “image”, as used in connection with block 110, may be any type of image. It may be a still image or a single frame a video stream. The image is captured by a mobile computing device, which may require using either the digital camera or digital video camera functionality of a mobile computing device. In some embodiments, the user must activate a mobile application on the user's mobile computing device before capturing the image of the invoice. In such embodiments, the mobile application may also activate and control the digital camera or digital video camera functionality of the phone. In other embodiments of the invention, the use may be able to upload a previously captured image to a mobile application.

Regarding block 110, the phrase “information associated with the image of an invoice” (also referred to herein as “invoice information”) refers to any type or quantity of information that is associated with the image of an invoice. In some embodiments, the information associated with the image of an invoice is the image of the invoice itself. In other embodiments, the information associated with the image of an invoice may comprise information that is ascertained from the image of the invoice, such as the amount of the invoice, the individual or entity that issued the invoice, or the products or services described in the invoice. In some embodiments, the mobile device of the user may include functionality that is capable of determining the information associated with the image of the invoice. For example, the mobile device may be able to analyze the image (e.g., image comparison analysis, pattern recognition analysis, character recognition or optical character recognition (i.e., “OCR”), and/or image recognition analysis) in order to ascertain the information associated with the image. In some embodiments, the information associated with the image is associated with the whole image, but in other embodiments, the information associated with the image may be associated with only a portion of the image.

The apparatus performing process flow 100 receives the invoice information via a network. In some embodiments, the apparatus receives the invoice information via a wireless and/or contactless network. In some embodiments, the apparatus receives the invoice information via second-generation (2G) wireless communication protocols (e.g., IS-136 (time division multiple access (TDMA), GSM (global system for mobile communication), and/or IS-95 (code division multiple access (CDMA)), third-generation (3G) wireless communication protocols (e.g., Universal Mobile Telecommunications System (UMTS), CDMA2000, wideband CDMA (WCDMA) and/or time division-synchronous CDMA (TD-SCDMA)), fourth-generation (4G) wireless communication protocols, and/or the like. In some other embodiments, the apparatus performing process flow 100 is configured to receive the invoice information in accordance with non-cellular communication mechanisms, such as via a wireless local area network (WLAN), global area network (GAN), a wide-area network (WAN), the Internet, and/or other communication/data networks. In other embodiments, the apparatus performing process flow 100 receives the transaction information through a hardwired connection.

At block 110, the apparatus performing process flow 100 receives the invoice information from the mobile computing device that captured the image. In some embodiments, the user executes an application on the mobile computing device in order to transmit the invoice information to the apparatus performing process flow 100. As one of skill in the art will appreciate, in other embodiments, the mobile computing device uses other means to transmit the invoice information to the apparatus performing process flow 100, such as SMS messages, email, or MMS messages.

Regarding block 120, the phrase “identify the invoice” refers identifying at least one of (i) individual or entity that issued the invoice; (ii) the products or services associated with the invoice; (iii) the amount of the invoice; (iv) the invoice number; or (v) any other information that would be used to identify the invoice.

At block 120, the apparatus performing process flow 100 uses any method to identify the invoice. In some embodiments, where the information associated with the image of the invoice is the image of the invoice, the apparatus performing process flow 100 analyzes (e.g., image comparison analysis, pattern recognition analysis, character recognition or optical character recognition (i.e., “OCR”), and/or image recognition analysis) the image to identify the invoice. In other embodiments, where the information associated with the image of the invoice is information ascertained from the image, the apparatus performing process flow 100 uses such information to identify the invoice.

The apparatus performing process flow 100 may identify the invoice by comparing the invoice information (or information obtained through an analysis of the invoice image) to information about known invoices. The apparatus performing process flow 100 may access a database of information about known invoices, such as the format of known invoices, invoice numbers for known invoices, etc. By comparing the invoice information to known information about invoices, the apparatus performing process flow 100 identifies the invoice. As an example, at block 110, if the apparatus performing process flow 100 receives an image of an invoice having a certain logo at the top, the apparatus could compare that logo to known invoices having the same logo in order to identify the invoice. As another example, at block 110, if the apparatus performing process flow 100 receives an invoice number, the apparatus could compare that invoice number to known invoices having the same invoice number or similar invoice number (i.e., number format, etc.) in order to identify the invoice.

Regarding block 130, the phrase “financial institution” means an institution that is associated with the user. Financial institutions can include, but are not limited to, banks, building societies, credit unions, stock brokerages, asset management firms, savings and loans, money lending companies, insurance brokerages, insurance underwriters, dealers in securities, and similar businesses.

As used in connection with block 130, the phrase “financial institution information associated with the invoice”, or “financial institution information” means any type or amount of information about the invoice that is known or available to the user's financial institution. The financial institution information may include, but is not limited to: (i) whether the invoice has been paid or not; (ii) when the invoice was paid; (iii) offers for products and/or services that are similar to those in the invoice but provided by a different individual or entity; (iii) offers for products and/or services that are competitive to those in the invoice; (v) offers for products and/or services that are complementary to those in the invoice; (vi) offers for products and/or services that are unrelated to those in the invoice; (vii) offers relating to the products and/or services of the invoice; (viii) offers for products and/or services that are provided by a merchant that is preferred by the user's financial institution. At block 130, the apparatus performing process flow 100 may determine one or more pieces of financial institution information associated with the invoice.

The apparatus performing process flow 100 uses any method to determine the financial institution information associated with the invoice. In some embodiments, after identifying the invoice at block 120, the apparatus performing process flow 100 compares invoice to a database of information to determine financial institution information associated with the invoice that is relevant to the invoice. This database of information may be maintained by the individual or entity that performs process flow 100 (e.g., the user's financial institution) or it may by maintained by a third party and made accessible to the individual or entity that performs process flow 100.

In some embodiments, the database of information may comprise information that is relevant to the invoice. For example, if the apparatus at block 120 identifies the invoice as being a cable service bill from Company X, then the apparatus may determine that financial institution information associated with the invoice comprises any of the following: (i) offers for discounts on cable service from Company X; (ii) offers for cable service from companies that compete with Company X; (iii) offers for movie tickets; (iv) offers for popcorn; (v) offers for a new television.

In other embodiments, the database of information comprises records of the user's financial institution. As another example, if the apparatus at block 120 identifies the invoice as being a medical bill from Hospital Z, then the apparatus may search the records of the financial institution to determine if the user paid the invoice from Hospital Z, and if so, when.

At block 140, the phrase “indication of the financial institution information” means any amount or type of information that is related to the financial institution information determined at block 130. For example, if the financial institution information determined at block 120 is that the invoice has not been paid, then the indication of the financial institution information could be an indication that the invoice has not been paid or an interface to facilitate payment of the invoice and/or an interface to allow the user to account for the payment in online services that manage the user's budget and finances. In some embodiments, the indication may enable the user to pay the invoice using any type of cloud payment method in which the user's payment information is stored in a remote location but accessible via the user's mobile device. In some embodiments, if the user is going to pay an invoice will foreign currency, the indication may allow the user to schedule a payment and lock in the current exchange rate for the foreign currency. In some embodiments, the indication may allow the user to schedule automatic or recurring payments for subsequent invoices from the merchant that issued the invoice.

As another example, if the financial institution information determined at block 120 is that the invoice has been paid, then the indication of the financial institution information could be an indication of such payment and details surrounding such payment (e.g., date paid, payment method, etc.). Further, the indication of the financial institution information could also enable the user to add the payment information to online services that manage the user's budget and finances.

As another example, if the financial institution information determined at block 120 comprises offers for products and/or services, then the indication of the financial institution information could be an interface to allow the user to accept such offers.

At block 140, the apparatus having process flow 100 presents, via the mobile computing device of the user, an indication of the financial institution information using any type of method known to those skilled in the art, including but not limited to, sending an email to the user, sending a SMS or MMS message to the user, displaying the indication on the display of the user's mobile computing device (e.g., a pop-up box, etc.), causing the user's mobile computing device to emit a sound and/or vibrate, shake, displaying the indication as part of a mobile application, etc. The indication of the mobile computing device of the user may be any size or shape. In some embodiments, the indication appears within a mobile application and contains text and/or pictures.

It will be understood that in some embodiments, at block 140, the apparatus performing process flow 100 may present more than one indications of financial institution information. Specifically, if the apparatus determines multiple pieces of financial institution information at block 130, then the apparatus will present an indication for each piece at block 140. The multiples indications may be presented in the same graphical display or they may be presented successively via the mobile computing device of the user.

Although not depicted in FIG. 1, in some embodiments, the apparatus having process flow 100 may categorize the invoice in connection with methods of managing the user's budget and finances. For example, in some embodiments, the entity that controls the apparatus having process flow 100 is the user's financial institution. By categorizing the user's invoice, the user's financial institution can provide an analysis of the user's budget based on categories (e.g., utilities, dining, entertainment, health or any other type of category) via an online banking functionality. In some embodiments, the apparatus having process flow 100 categorizes the invoice when it identifies the invoice at block 120. For instance, if the apparatus identifies the invoice as being issued by a cable company, the apparatus would categorize the invoice as relating to “utilities.” In other embodiments, the user may be prompted to categorize the invoice after capturing an image of the invoice. In other embodiments, where the user has categorized past purchases via banking functionality (or after previously capturing similar invoices), the apparatus may compare the current invoice to past purchases to determine its category. For instance, the user may have categorized prior medical invoices as “health.” Thus, to the extent the apparatus identifies another invoice from the same doctor, it would automatically categorize the invoice as “health.” In still another embodiment, the issuer of the invoice might place a bar code, QR code, or any other type of indicia on the invoice such that the apparatus analyzes the image of the indicia to determine how to categorize the invoice.

At optional block 150, the apparatus having process flow 100 transmits user information to the individual or entity that issues the invoice. As used herein, the term “user information” means any information relating to the user capturing the invoice with the mobile device.

In some embodiments, the user information is an indication that the user received the invoice. Thus, the issuer of the invoice will know that it was received by the user because the user captured an image of it using a mobile device. In some other embodiments, the apparatus having process flow 100 may transmit an indication of the cumulative number or percentage of customers that received their invoices based upon the number of user's that capture an image of their respective invoice.

In some other embodiments where process flow 100 enables a user to pay an invoice, the user information could be (i) an indication that the user has paid the invoice; (ii) an indication that a payment is pending; (iii) the date on which the user has scheduled to pay the invoice; (iv) or the payment method that the user has chosen to pay the invoice.

As one of skill in the art will appreciate, the user information may be any type of information that is known, transmitted to, or made accessible to the entity that controls the apparatus having process flow 100.

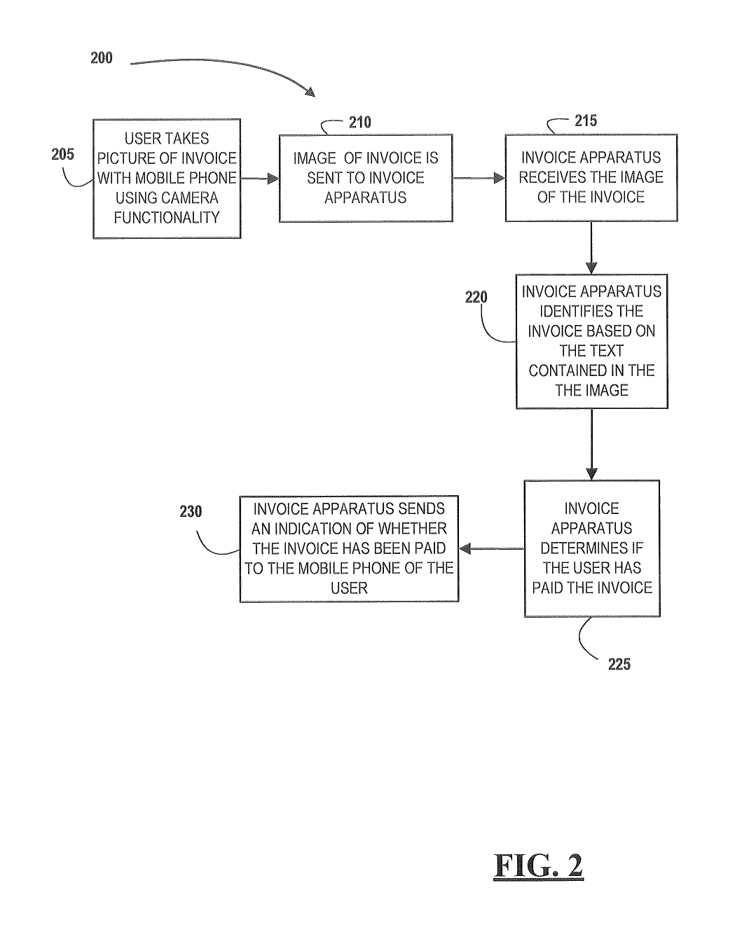

Referring now to FIG. 2, a more-detailed process flow 200 for electronic processing of paper invoices is provided, in accordance with an embodiment of the present invention. In some embodiments, one or more portions of the process flow 200 are performed by an apparatus having hardware and/or software configured to perform one or more portions of the process flow 200. In some of these embodiments, the apparatus configured to perform the process flow 100 is also configured to perform the process flow 200. As such, it will be understood that the process flow 200 illustrated in FIG. 2 represents an example embodiment of the process flow 100 described in connection with FIG. 1. More specifically, FIG. 2 represents and embodiment of the invention where block 205 is performed by a mobile phone (which is an example of mobile computing device 425) and blocks 210-230 are performed by an invoice apparatus (which is an example of invoice apparatus 430), which is maintained by the user's financial institution.

Referring to block 205, the user takes a picture of an invoice with her mobile phone. In this embodiment of the invention, the user must access a mobile application on her mobile phone, which enables the user to take a picture of the invoice that she would like to process.

At block 210, the image of the invoice is sent to the invoice apparatus. In this embodiment of the invention, the image of the invoice is sent to the invoice apparatus over a cellular network. However, as one of skill in the art will appreciate, in other embodiments if the invention, the image is sent to the invoice apparatus over a different type of communications network, such as a Wi-Fi network or Bluetooth network. At block 215, the invoice apparatus receives the image of the invoice.

At block 220, the invoice apparatus identifies the invoice based on the image sent to it at block 210. In this embodiment of the invention, the invoice apparatus uses OCR to analyze the image and identify the invoice based on the text contained in the image, including but not limited to the name of the merchant that issued the invoice, the date of the invoice, the amount of the invoice, and the invoice number. In some embodiments, the invoice apparatus may identify the invoice by searching a database and comparing the text contained in the image to text from known invoices. As one of skill in the art will appreciate, the database in which the invoice apparatus searches may associate a particular invoice with certain keywords (e.g., Merchant name, etc.), formatting (i.e., invoice numbers for a certain merchant always begin with an “ABC” prefix) or other distinguishing characteristics. This database may be maintained by the financial institution or maintained by a third party who provides access to the financial institution.

At block 225, the invoice apparatus searches the searches the user's financial records to determine whether the user has paid the invoice. Having identified the invoice at block 220, the invoice apparatus searches the financial records to determine whether the user paid the invoice. In particular, the invoice apparatus can search the financial records to determine whether the user made a payment to the merchant (identified at block 220) for the amount of the invoice (identified at block 220). If the invoice apparatus identifies such a payment, then it determines that the user paid the invoice. If the invoice apparatus does not identify such a payment, then it determines that the user has not paid the invoice.

At block 230, the invoice apparatus sends an indication of whether the invoice has been paid to the mobile phone of the user. In this embodiment of the invention, the indication is displayed within the mobile application that the user executed at block 205. The indication provides text and graphics and informs the user whether the user has paid the invoice or not. In this embodiment of the invention, the invoice apparatus sends the indication to the mobile phone via a cellular network; however, in other embodiments of the invention, the invoice apparatus may send the indication to the user's mobile phone using any other type of communications network.

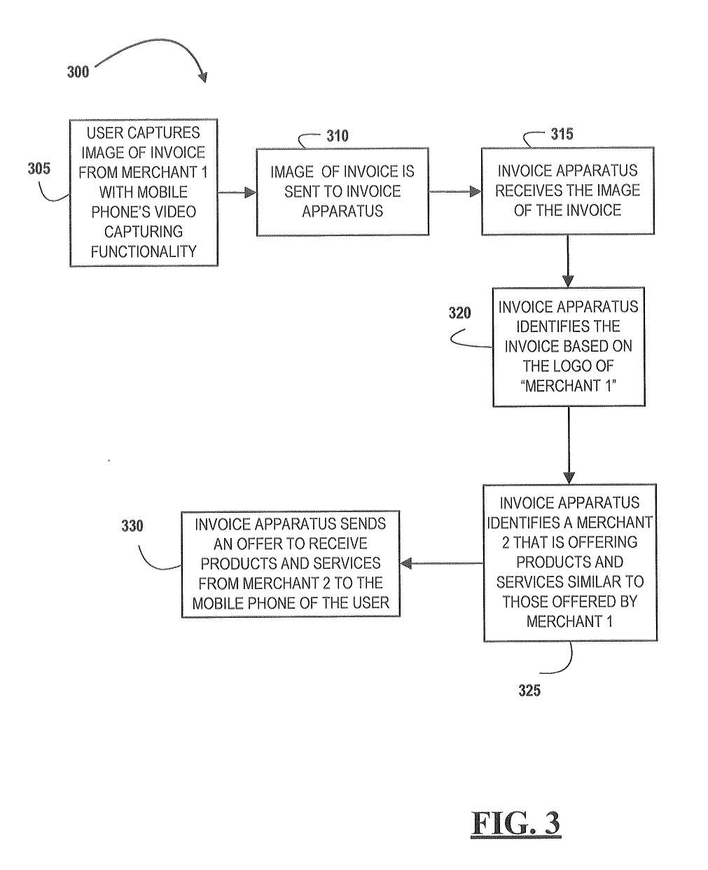

Referring now to FIG. 3, a more-detailed process flow 300 for electronic processing of paper invoices is provided, in accordance with an embodiment of the present invention. In some embodiments, one or more portions of the process flow 300 are performed by an apparatus having hardware and/or software configured to perform one or more portions of the process flow 300. In some of these embodiments, the apparatus configured to perform the process flow 100 is also configured to perform the process flow 300. As such, it will be understood that the process flow 300 illustrated in FIG. 3 represents an example embodiment of the process flow 100 described in connection with FIG. 1. More specifically, FIG. 3 represents and embodiment of the invention where block 305 is performed by a mobile phone (which is an example of mobile computing device 425) and blocks 210-230 are performed by an invoice apparatus (which is an example of invoice apparatus 430), which is maintained by the user's financial institution.

Referring to block 305, the user captures an image of an invoice from Merchant 1 with her mobile phone. In this embodiment of the invention, the user must access a mobile application on her mobile phone, which enables the user to activate the video recording functionality of the mobile phone. By capturing a real-time video stream of the invoice, the user can capture at least one image of the invoice that she would like to process.

At block 310, the image of the invoice is sent to the invoice apparatus. In this embodiment of the invention, the image of the invoice is sent to the invoice apparatus over a cellular network. However, as one of skill in the art will appreciate, in other embodiments if the invention, the image is sent to the invoice apparatus over a different type of communications network, such as a Wi-Fi network or Bluetooth network. At block 315, the invoice apparatus receives the image of the invoice.

At block 320, the invoice apparatus identifies the invoice based on the image sent to it at block 310. In this embodiment of the invention, the invoice apparatus uses image recognition analysis to identify the logo of Merchant 1, which appears at the top of the invoice. By identifying the logo of Merchant 1 and subsequently Merchant 1's identity, the invoice apparatus is able to determine the products and service that are offered by Merchant 1. In this embodiment of the invention, the invoice apparatus accesses a database containing entries of which products and services and offered by Merchant 1.

At block 325, the invoice apparatus searches a database to identify a Merchant 2, which offers products and services that are similar to those provided by Merchant 1. In this embodiment of the invention, Merchant 2 has a preferred relationship with the financial institution of the user and thus, offers discounts, coupons, favorable pricing, deals, etc. to the financial institutions customers. As one of skill in the art will appreciate, the database in which the invoice apparatus searches may associate the products and services of Merchant 1 with the products and services with Merchant 2. This database may be maintained by the financial institution or maintained by a third party who provides access to the financial institution.

At block 330, the invoice apparatus sends an offer to receive products and services from Merchant 2 to the mobile phone of the user. In this embodiment of the invention, the indication is displayed within the mobile application that the user executed at block 305. The indication provides text and graphics and informs the user that the user has been offered an opportunity to receive products and services from Merchant 2. In this embodiment of the invention, the invoice apparatus sends the indication to the mobile phone via a cellular network; however, in other embodiments of the invention, the invoice apparatus may send the indication to the user's mobile phone using any other type of communications network.

FIG. 4 provides a block diagram illustrating a system and environment 400 for electronic processing of paper invoices, in accordance with an embodiment of the invention. As illustrated in FIG. 4, the environment 400 includes a user 420 and a mobile computing device 425 associated with user 420. The environment 400 also includes an invoice apparatus 430 and invoice issuer computer system 450.

Personal computing device 425 and invoice apparatus 430 are each configured to communicate with each other over a network 410. Additionally, invoice issuer computer system 450 and invoice apparatus 430 are each configured to communicate with each other over a network 410. The network 410 may include a local area network (LAN), a wide area network (WAN), a global area network (GAN), near field communication network, Bluetooth network or any other type of communications network or protocol. In some embodiments, network 410 may comprise the Internet. In addition, network 410 may include first, second, third, and/or fourth-generation cellular communication networks and/or the like. For example, the network 410 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 410 may provide for wired, wireless, or a combination of wired and wireless communication between devices on the network.

As one of skill in the art will appreciate, network 410 may comprise one or more different networks. For instance, network 410 may comprise a cellular communication network, the Internet, and a Bluetooth network. Thus, invoice apparatus 430 may communicate with personal computing device 425 over a different type of communication network than it uses to communicate with invoice issuer computer system 450. For instance, personal computing device 425 and invoice apparatus 430 may communicate with each other over a cellular communications network and invoice issuer computer system 450 and invoice apparatus 430 may communicate with each other via the Internet.

The invoice apparatus 430 generally includes a processor 432 communicably coupled to such devices as a memory 436 and communication interface 434.

The processor 432 and other processors described herein may generally include circuitry for implementing communication and/or logic functions of the invoice apparatus 430. For example, the processor 430 may include a digital signal processor device, a microprocessor device, and various analog to digital converters, digital to analog converters, and/or other support circuits. Control and signal processing functions of the invoice apparatus 430 may be allocated between these devices according to their respective capabilities. The processor 432 thus may also include the functionality to encode and interleave messages and data prior to modulation and transmission. The processor 432 may additionally include an internal data modem. Further, the processor 432 may include functionality to operate one or more software programs or applications, which may be stored as computer-readable code in the memory 436.

The processor 432 may be configured to use the communication interface 434 to communicate with one or more other devices on a network. The processor 432 may be configured to provide signals to and receive signals from the communication interface 434. In some embodiments, the signals may include signaling information in accordance with the air interface standard of the applicable cellular system of the wireless telephone network that may be part of the network. In this regard, the invoice apparatus 430 may be configured to operate with one or more air interface standards, communication protocols, modulation types, and access types. For example, the invoice apparatus 430 may be configured to operate in accordance with second-generation (2G) wireless communication protocols, third-generation (3G) wireless communication protocols, fourth-generation (4G) wireless communication protocols, and/or the like. The invoice apparatus 430 may also be configured to operate in accordance with non-cellular communication mechanisms, such as via a wireless local area network (WLAN), global area network (GAN), a wide-area network (WAN), the Internet, and/or other communication/data networks.

As further illustrated in FIG. 4, the invoice apparatus 430 includes memory 436. In some embodiments, the memory 436 contains invoice application 438 and database 440. Invoice application 438 includes computer code that, when executed by the processor 432, performs one or more of the functions described herein in relation to the invoice apparatus 430. In some embodiments, invoice application 438 is configured to perform the process described in relation to blocks 110 to 140 of FIG. 1. The memory 436 also includes data stored therein, such as database 440. Database 440 may comprise banking information, financial institution records, financial institution information (as that term is used in connection with block 130), information about known invoices, or any other information that could be used by the invoice apparatus to identify an invoice (as in block 120) or determine financial institution information (as in block 130). In some embodiments, invoice apparatus 430 may be maintained and stored by a financial institution, third-party service provider, and/or any other entity that wishes to provide the functionality described herein. In other embodiments, invoice apparatus 430 or portions thereof may be incorporated into personal computing device 425. Although in the embodiment of the invention depicted at FIG. 4, database 440 is stored in memory 436, in other embodiments, database 440 is stored remotely from invoice apparatus 430 and accessible to the invoice apparatus 430 via network 410.

Although not depicted in FIG. 4, memory 436 of invoice apparatus may also include invoice data 442. Invoice data 442 comprises the information associated with the image of an invoice that is received by invoice apparatus 430 from mobile computing device (see block 110).

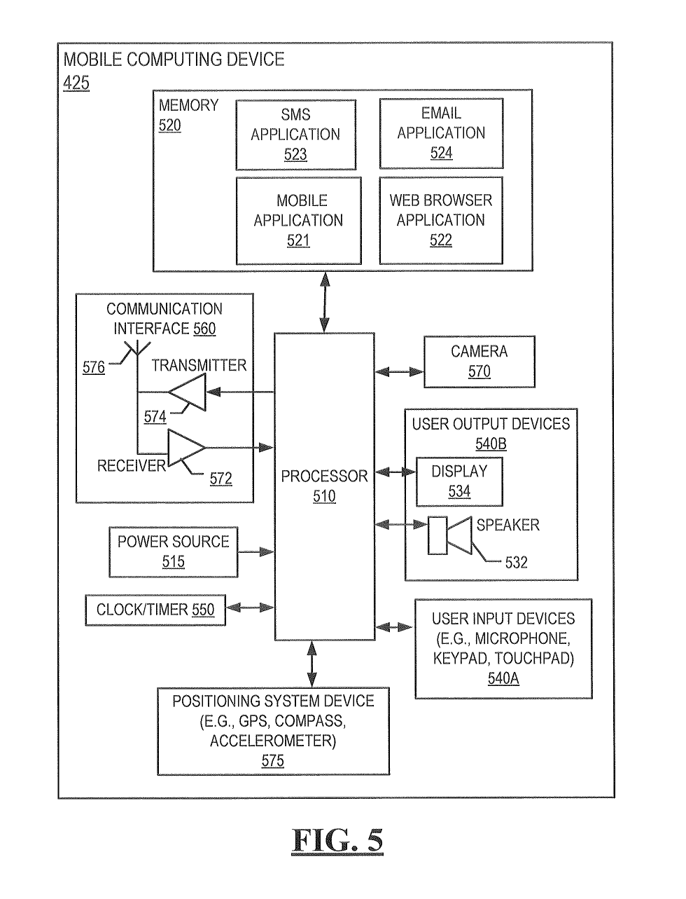

Mobile computing device 425 may comprise any type of mobile computing device, including but not limited to a mobile phone, smart phone, tablet computer, personal digital assistant, gaming device, etc. Although not depicted in FIG. 4, mobile computing device 425 will generally comprise a processor, communication interface, and memory. The processor described in connection with mobile computing device 425 may generally include circuitry for implementing communication and/or logic functions of mobile computing device 425. The processor may be configured to use the communication interface to communicate with one or more other devices on a network. The processor may be configured to provide signals to and receive signals from the communication interface. Additionally, the mobile computing device 425 includes memory. In some embodiments, the memory contains one or more applications having computer code that, when executed by the processor of mobile computing device 425, performs one or more of the functions described herein in relation to mobile computing device 425. An embodiment of mobile computing device 425 will be described in greater detail in connection with FIG. 5.

Invoice issuer computing system 450 comprises any type of computing system used by the issuer of an invoice. Invoice issuer computing system 450 may be a desktop computer, a laptop computer, a tablet computer, a mobile computing device, or any other type of computer system known to one of skill in the art. Although not depicted in FIG. 4, invoice issuer computing system 450 generally comprises a communication interface, a processor, and memory.

FIG. 5 depicts a detailed illustration of mobile computing device 425, in accordance with an embodiment of the present invention. In this embodiment, personal mobile device 425 is a mobile computing device (e.g., mobile phone, pda, etc.). As depicted in FIG. 5, mobile computing device 425 may generally include a processor 510 communicably coupled to such devices as a memory 520, user output devices 540B, user input devices 540A, a communication interface 560, a power source 515, a clock or other timer 550, a camera 570, and positioning system device 575.

As depicted in FIG. 5, the processor 510 may be configured to use the communication interface 560 to communicate with one or more other devices on a network. In this regard, the communication interface 560 may include an antenna 576 operatively coupled to a transmitter 574 and a receiver 572 (together a “transceiver”). The processor 510 may be configured to provide signals to and receive signals from the transmitter 574 and the receiver 572, respectively. The signals may include signaling information in accordance with the air interface standard of the applicable cellular system of the wireless telephone network that may be part of the network. In this regard, the personal computing device 425 may be configured to operate with one or more air interface standards, communication protocols, modulation types, and access types. In some embodiments, mobile computing device 425 may be configured to operate in accordance with second-generation (2G) wireless communication protocols, third-generation (3G) wireless communication protocols, and/or fourth-generation (4G) wireless communication protocols, and/or the like. The mobile computing device 425 may also be configured to operate in accordance with non-cellular communication mechanisms, such as via a WLAN, WAN, GAN, the Internet and/or other communication/data networks.

As described above, the mobile computing device 425 may have a user interface 540 that includes user output devices 540B and/or user input devices 540A. The user output devices 540B may include a display 534 (e.g., a liquid crystal display (LCD) or the like) and a speaker 532 or other audio device, which are operatively coupled to the processor 510. The user input devices 540A, which may allow the mobile computing device 425 to receive data from the user 420, may include any of a number of devices allowing the mobile computing device 312 to receive data from a user, such as a keypad, keyboard, touch-screen, touchpad, microphone, mouse, joystick, other pointer device, button, soft key, and/or other input device(s).

The mobile computing device 425 may further include a power source 515. Generally, the power source 515 is a device that supplies electrical energy to an electrical load. In one embodiment, the power source 515 may convert a form of energy such as solar energy, chemical energy, mechanical energy, etc. to electrical energy. Generally, the power source 515 in the mobile computing device 425 may be a battery, such as a lithium battery, a nickel-metal hydride battery, or the like, that is used for powering various circuits, e.g., the transceiver circuit, and other devices that are used to operate the mobile computing device 425. Alternatively, the power source 515 may be a power adapter that can connect a power supply from a power outlet to the mobile computing device 425. In such embodiments, a power adapter may be classified as a power source “in” the mobile computing device.

The mobile computing device 425 may also include a camera 570. In some embodiments, camera 570 may take still photographs. In other embodiments, camera 570 may capture video. In still some other embodiments, camera 570 may take both still photographs and capture video.

The mobile computing device 425 may also include a memory 520 operatively coupled to the processor 510. As used herein, memory may include any computer readable medium configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory may additionally or alternatively include an electrically erasable programmable read-only memory (EEPROM), flash memory or the like.

The memory 520 may store any of a number of applications or programs which include computer-executable instructions/code executed by the processor 510 to implement the functions of the mobile computing device 425 described herein. For example, the memory 520 may include such applications as a mobile application 521, a web browser application 522, an SMS application 523, an email application 524, etc. Although not depicted in FIG. 5, in other embodiments of the invention, the memory 520 may store all or part of invoice application 438 and/or bank records 440. Mobile application 521 may enable the mobile computing device 425 to capture an image of an invoice for processing (as described in connection with block 110) and also enable the receipt and display of indications of financial institution information (as described in connection with block 140).

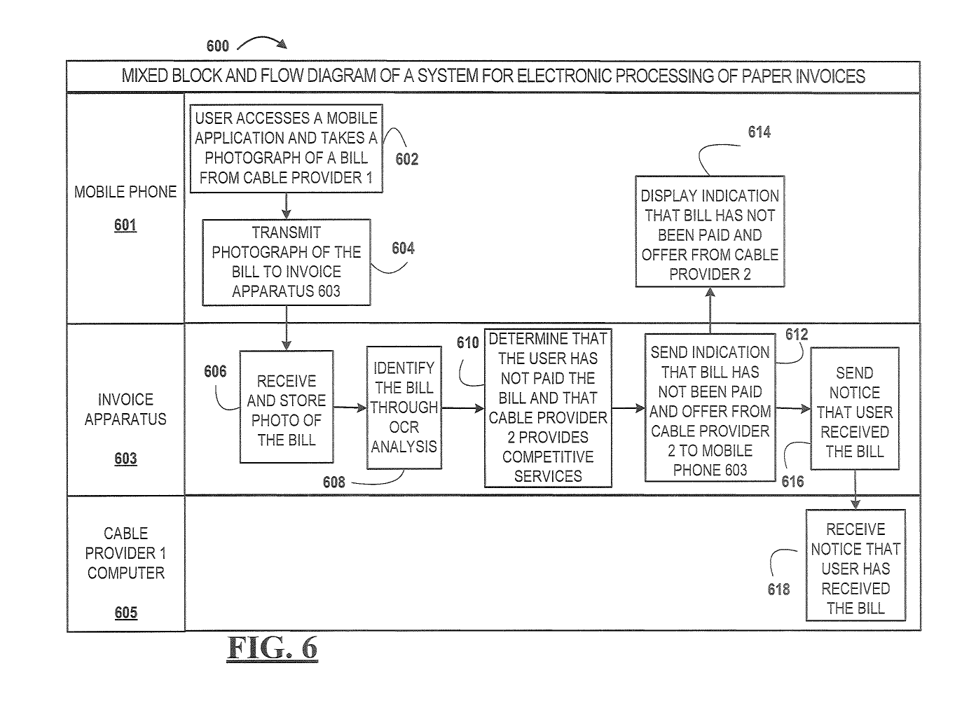

Referring now to FIG. 6, a mixed block and flow diagram of a system 600 is provided for the electronic processing of paper invoices. It will be understood that the system 600 illustrated in FIG. 6 represents an embodiment of the process flow 100 described in connection with FIG. 1. In general terms, FIG. 6 illustrates an embodiment of the method of the present invention. In this embodiment, a user (“User”) desires to process a bill from Cable Provider 1 in order to receive information about that invoice. Mobile phone 601 is an embodiment of mobile computing device 425, as is depicted in FIG. 5. Invoice apparatus 603 is an embodiment of invoice apparatus 430, as depicted in FIG. 4. Cable Provider 1 computer 605 is an embodiment of invoice issuer computer system 450, as depicted in FIG. 4.

As depicted at block 602, User accesses a mobile application stored on mobile phone 601. After opening this mobile application, the user takes a photograph of a bill from Cable Provider 1.

At block 604, the mobile phone 601 transmits this photograph to invoice apparatus 603. In this embodiment of the invention, after taking the photograph of the bill, the user indicates to the mobile application that he would like to transmit the photograph to invoice apparatus 603. The user may make this indication using any means, including interacting with the user input devices of mobile phone 601. At block 604, the photograph is transmitted to invoice apparatus 603 via a cellular network and at block 606 the user apparatus receives this photograph of the bill and stores in in memory.

At block 608, the invoice apparatus 603 identifies the bill through an OCR analysis of the image of the bill. By performing an OCR analysis of the bill, invoice apparatus 603 identifies (i) Cable Provider 1 as the merchant that issued the bill; (ii) the amount of the bill; (iii) the products and services for which the bill was issued; and (iv) the date the bill is due. Although in this embodiment of the invention, the invoice apparatus performs an OCR analysis, in other embodiments, the invoice apparatus performs a different type of analysis and/or compares information about the bill to information about known invoices.

At block 610, invoice apparatus 603 determines that the user has not paid the bill from Cable Provider 1. Having identified the bill from Cable Provider 1 at block 610, the invoice apparatus searches the financial records of User to determine whether User has already paid the bill. At block 610, financial apparatus 603 determines that User has not paid the bill from Cable Provider 1 because the financial records relating to User do not indicate that a payment equaling an amount due to Cable Provider 1 has not made since the issuance of the bill.

Additionally, at block 610, invoice apparatus identifies Cable Provider 2, which provides competitive services to Cable Provider 1. Having identified Cable Provider 1 at block 610, invoice apparatus 603 accesses a database that indicates the services that are provided by Cable Provider 1, as well as similar services that are provided by merchants that compete with Cable Provider 1, such as Cable Provider 2. This database also contains information relating to offers from Cable Provider 2 that are available to User.

At block 612, invoice apparatus 603 sends an indication to mobile phone 601 that (i) the bill from Cable Provider 1 has not been paid; and (ii) the User has on offer from Cable Provider 2 for services that are competitive to those of the invoice from Cable Provider 1. In this embodiment of the invention, this indication is sent via a cellular network.

At block 614, mobile device 601 receives the indication that (i) the bill from Cable Provider 1 has not been paid; and (ii) the User has on offer from Cable Provider 2 for services that are competitive to those of the invoice from Cable Provider 1. In this embodiment of the invention, the indication is displayed within the interface of the mobile application that the user executed at block 602. However in other embodiments, the indication could appear as a text message, MMS message, email, voicemail, etc.

In this embodiment of the invention, the indication indicates that User has not paid the bill from Cable Provider 1. The indication provides the User with functionality to pay the bill from Cable Provider 1 via mobile device 601 (or alternatively, schedule a future payment of the Bill). The indication also allows User to integrate this bill into other services provided by User's financial institution, such as an online budget, graphical depictions/representations of expenditures, and other services that allow User to manage personal finances. Additionally, the indication alerts User to the offer from Cable Provider 2 to obtain services that are competitive to those from Cable Provider 1. This offer could be any kind of offer (i.e., one month free, trial subscription, one-time discount, etc.) In some embodiments, User can redeem the offer via mobile phone 601. In this embodiment, the indication contains graphics, images, and text, but as one of skill in the art will appreciate, the indication could be formatted in any way.

At block 616, invoice apparatus 603 sends a notice to Cable Provider 1 computer 605 that the User has received the bill. Since the User captured a photograph of the bill at block 602, invoice apparatus 603 determines that the User has received the bill. At block 616 this notice is sent to Cable Provider 1 computer 605 via the Internet and at block 618, Cable Provider 1 computer 605 receives the notice.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

This application incorporates by reference in their entirety each of the following applications filed concurrently herewith: U.S. application Ser. No. ______, entitled BILL CONTROL, filed Jul. 6, 2012 to Carrie Hanson et al. (Atty. Dkt. 5163US1.014033.1650); U.S. application Ser. No. ______, entitled FINANCIAL DOCUMENT PROCESSING SYSTEM, filed Jul. 6, 2012 to Carrie Hanson et al. (Atty. Dkt. 5169US1.014033.1661); U.S. application Ser. No. ______, entitled TRANSACTION MONITORING AND SAVINGS FEATURE, filed Jul. 6, 2012 to Carrie Hanson et al. (Atty. Dkt. 5172US1.014033.1663); U.S. application Ser. No. ______, entitled BILL PAYMENT MANAGEMENT, filed Jul. 6, 2012 to Carrie Hanson et al. (Atty. Dkt. 5173US1.014033.1662); U.S. application Ser. No. ______, entitled EARNING REWARDS VIA BILL PAYMENT, filed Jul. 6, 2012 to Carrie Hanson et al. (Atty. Dkt. 5174US1.014033.1649); U.S. application Ser. No. ______, entitled FUTURE ACCOUNT VIEW, filed Jul. 6, 2012 to Carrie Hanson et al. (Atty. Dkt. 5175US1.014033.1651); and U.S. application Ser. No. ______, entitled CALENDAR BILL PAYMENT MANAGEMENT, filed Jul. 6, 2012 to Carrie Hanson et al. (Atty. Dkt. 5190US1.014033.1652).

1. An apparatus for providing financial institution information associated with an invoice, the apparatus comprising:
a communication device, and
a processing device communicable coupled to the communication device, wherein the processing device is configured to:
receive, from a mobile computing device of a user, information associated with an image of the invoice, wherein the image is captured by the mobile computing device of the user, wherein the mobile computing device is a mobile phone with a camera, wherein the user received the invoice from the merchant as a paper invoice, wherein the user does not receive an electronic invoice from the merchant, and wherein the processing device is not configured to receive a paper invoice or an electronic invoice from the merchant;
identify the invoice based at least partially upon the information associated with the image of the invoice and based at least partially on comparing a format of the image of the invoice to a format of a second invoice in a database of invoices;
determine financial institution information associated with the invoice, wherein the financial institution information associated with the invoice at least comprises an indication of the merchant and whether the invoice has been paid by the user; and
present, via the mobile computing device of the user, an indication of the financial institution information.

2. The apparatus of claim 1, wherein the processing device configured to receive information associated with an image of the invoice is further configured to receive an image of the invoice.

3. The apparatus of claim 1, wherein the processing device configured to identify the invoice is further configured to identify at least one of the name of the first merchant, the invoice number, the products or services subject to the invoice, or the amount of the invoice.

4. The apparatus of claim 1, wherein the processing device configured to identify the invoice is further configured to analyze the image of the invoice.

5. (canceled)

6. The apparatus of claim 1, wherein the processing device configured to present an indication of the financial institution information is further configured to present an indication of whether the invoice has been paid.

7. The apparatus of claim 6, wherein the processing device configured to present an indication of whether the invoice has been paid is further configured to allow the user, via the mobile device of the user, to add the invoice to an online representation of the user's expenses.

8. The apparatus of claim 1, wherein the processing device configured to determine financial institution information associated with the invoice is further configured to identify a second merchant, wherein the second merchant provides products or services that are substantially the same as those offered by the first merchant.

9. The apparatus of claim 1, wherein the processing device configured to present an indication of financial institution information is further configured to present an offer to enter into a transaction with a second merchant.

10. The apparatus of claim 9, wherein the processing device configured to present an offer to enter into a transaction with the second merchant is further configured to present an offer to enter into a transaction with a second merchant that has a preferred relationship with the user's financial institution.

11. A computer implemented method for providing financial institution information associated with an invoice, wherein the invoice is issued by a first merchant to a user, the computer implemented method comprising:
providing a computer processor executing computer readable code structured to cause the computer processor to:
receive, from a mobile computing device of a user, information associated with an image of the invoice, wherein the image is captured by the mobile computing device of the user, wherein the mobile computing device is a mobile phone with a camera, wherein the user received the invoice from the merchant as a paper invoice, wherein the user does not receive an electronic invoice from the merchant, and wherein the computer processor is not caused to receive a paper invoice or an electronic invoice from the merchant;
identify the invoice based at least partially upon the information associated with the image of the invoice and based at least partially on comparing a format of the image of the invoice to a format of a second invoice in a database of invoices;
determine financial institution information associated with the invoice, wherein the financial institution information associated with the invoice at least comprises an indication of whether the invoice has been paid by the user; and
present, via the mobile computing device of the user, an indication of the financial institution information.

12. The method of claim 11, wherein receiving information associated with an image of the invoice comprises receiving an image of the invoice.

13. The method of claim 11, wherein identifying the invoice comprises identifying at least one of the name of the first merchant, the invoice number, the products or services subject to the invoice, or the amount of the invoice.

14. The method of claim 11, wherein identifying the invoice comprises analyzing the image of the invoice.

15. (canceled)

16. The method of claim 11, wherein presenting an indication of the financial institution information comprises presenting an indication of whether the invoice has been paid.

17. The method of claim 16, wherein presenting an indication of whether the invoice has been paid comprises allowing the user, via the mobile device of the user, to add the invoice to an online representation of the user's expenses.

18. The method of claim 11, wherein determining financial institution information associated with the invoice comprises identifying a second merchant, wherein the second merchant provides products or services that are substantially the same as those offered by the first merchant.

19. The method of claim 11, wherein presenting an indication of financial institution information comprises presenting an offer to enter into a transaction with a second merchant.

20. The method of claim 19, wherein presenting an offer to enter into a transaction with the second merchant comprises presenting an offer to enter into a transaction with a second merchant that has a preferred relationship with the user's financial institution.

21. A computer program product providing financial institution information associated with an invoice, the computer program product comprising a non-transitory computer-readable medium, wherein the non-transitory computer-readable medium comprises computer executable program code store therein, the computer executable program code comprises:
a first executable portion configured to receive, from a mobile computing device of a user, information associated with an image of the invoice, wherein the image is captured by the mobile computing device of the user, wherein the mobile computing device is a mobile phone with a camera, wherein the user received the invoice from the merchant as a paper invoice, wherein the user does not receive an electronic invoice from the merchant, and wherein the first executable portion is not configured to receive a paper invoice or an electronic invoice from the merchant;
a second executable portion configured to identify the invoice based at least partially upon the information associated with the image of the invoice and based at least partially on comparing a format of the image of the invoice to a format of a second invoice in a database of invoices;
a third executable portion configured to determine financial institution information associated with the invoice, wherein the financial institution information associated with the invoice at least comprises an indication of whether the invoice has been paid by the user; and
a fourth executable portion configured to present, via the mobile computing device of the user, an indication of the financial institution information.

22. The computer program product of claim 21, wherein the first executable portion configured to receive information associated with an image of the invoice is further configured to receive an image of the invoice.

23. The computer program product of claim 21, wherein the second executable portion configured to identify the invoice is further configured to identify at least one of the name of the first merchant, the invoice number, the products or services subject to the invoice, or the amount of the invoice.

24. The computer program product of claim 21, wherein the second executable portion configured to identify the invoice is further configured to analyze the image of the invoice.

25. The computer program product of claim 21, wherein the third executable portion configured to determine financial institution information associated with the invoice is further configured to determine whether the invoice has been paid by the user.

26. (canceled)

27. The computer program product of claim 26, wherein the fourth executable portion configured to present an indication of whether the invoice has been paid is further configured to allow the user, via the mobile device of the user, to add the invoice to an online representation of the user's expenses.

28. The computer program product of claim 21, wherein the third executable portion configured to determine financial institution information associated with the invoice is further configured to identify a second merchant, wherein the second merchant provides products or services that are substantially the same as those offered by the first merchant.

29. The computer program product of claim 21, wherein the fourth executable portion configured to present an indication of financial institution information is further configured to present an offer to enter into a transaction with a second merchant.

30. The computer program product of claim 29, wherein the fourth executable portion configured to present an offer to enter into a transaction with the second merchant is further configured to present an offer to enter into a transaction with a second merchant that has a preferred relationship with the user's financial institution.
